(19) United States
(12) Patent Application Publication
(10) Pub. No.: US 2021/0260790 A1
(43) Pub. Date: Aug. 26, 2021

(54) MODIFIED WOODEN SHEET, METHOD FOR PRODUCING SAME, AND MODIFYING AGENT

(71) Applicant: DAICEL CORPORATION, Osaka-shi, Osaka (JP)

(72) Inventor: Yuichiro EGAWA, Tokyo (JP)

(73) Assignee: DAICEL CORPORATION, Osaka-shi, Osaka (JP)

(21) Appl. No.: 17/254,024

(22) PCT Filed: Jun. 19, 2019
(86) PCT No.: PCT/JP2019/025507

§ 371 Date: Dec. 18, 2020

(30) Foreign Application Priority Data
Jun. 20, 2018 (JP) 2018-117113

(51) Int. Cl. B27K 3/52; B27K 3/20; B27K 3/36

(52) U.S. Cl. CPC B27K 3/52; B27K 3/36; B27K 3/20

(57) ABSTRACT

Provided is a wooden sheet having high flexibility (for example, folding resistance) and processability (for example, degree of processing freedom) even if the wooden sheet is considerably thick. Also provided is a method that can be used to produce such a wooden sheet. The wooden sheet is modified with a modifying agent including a combination of an acid or an alkali and a compound having a hydroxyl group.

### TECHNICAL FIELD

The present invention relates to a modified wooden sheet, a method for producing a wooden sheet, and a modifying agent. The present application claims the rights of priority of JP 2018-117113 filed in Japan on Jun. 20, 2018, the content of which is incorporated herein.

### BACKGROUND ART

Natural wood sheets that have been processed into thin sheets through methods such as slicing natural wood are used to decorate buildings, vehicles, furniture, electrical products, and the like. However, such natural wood sheets are prone to breakage due to the thinness thereof, and are therefore often commercially available as a reinforced sheet such as a wooden sheet having a backing containing reinforcing fibers, resin, or the like. However, such a backing containing reinforcing fibers, resin, or the like may be limited in increasing flexibility and processability, and may require extra labor and costs.

Also, in the use of natural wood sheets, the need to resolve changes in dimensions and deterioration over time has become a significant issue. Natural wood is rich in water and undergoes changes in dimensions (for example, deformation and contraction) over time as drying progresses. Thus, for example, a natural wood sheet used on the wall surface of a building, in the interior of a vehicle, or on the surface of furniture or an electrical product may experience a change in dimensions, cracking, or peeling, when dried. Deterioration of natural wood sheets is also caused by moisture in the wood. For example, if the wood has not been sufficiently dried, deterioration is caused by the moisture originally present in the natural wood sheet. In addition, when the humidity in the air is high, the natural wood sheet absorbs the moisture, and deterioration proceeds accordingly. Furthermore, the increase in the wood moisture content facilitates growth and propagation of fungi (for example, wood rotting fungi) or insects (for example, termites and bark beetles) that feed on the wood, and deterioration further progresses. In particular, it is conceivable that, to make use of the texture or feel of a natural wood sheet, a protective layer may not be provided on the surface thereof, but in this case, the effects of drying, moisture absorption, and damage by insects are also significant, and the problems described above are likely to occur.

Another problem that must be addressed with a natural wood sheet is the presence of voids in the wood. Voids are present in the wood as conduits and phloem in the wood. Also, voids may be present due to the drying of moisture in the cells of the wood or between the cells. In such voids in the wood, wood components such as cellulose and lignin are in contact with air, and may undergo changes. Therefore, the change in the dimensions over time (i.e., shrinkage over time) becomes even more pronounced. Furthermore, moisture absorption by a natural wood sheet causes deterioration as described above, and it is thought that such moisture absorption is promoted by the affinity between the moisture in the air and hydrophilic groups such as hydroxyl groups present in the lignin, cellulose, and the like in the wood. Accordingly, it is thought that the increase in voids in the wood increases the contact area between the air and the wood, which in turn results in moisture absorption due to the affinity between the hydrophilic groups in the wood and the moisture in the air, and as a result, deterioration of the wood is further promoted.

As described above, problems to be solved with natural wood sheets include deterioration and the change in dimensions over time due to moisture and voids in the wood. As a means to solve this, an acetylation treatment of wood is known. However, such treatment requires equipment that supports high temperatures and high pressures, and predetermined safety measures for handling acetic anhydride are required. Thus, such treatment requires extra labor and cost. Moreover, the acetylation treatment may not provide improvements in flexibility and processability. As another means, technology for impregnating a natural wood sheet with polyethylene glycol and a resin such as hydroxycellulose is known (Patent Document 1). In this technology, the moisture in the wood is replaced and removed by the resin, the voids in the wood is filled with the resin and thereby reinforced, and the wood (especially the hydrophilic groups) is coated (blocked) by the resin. Through this technology, sheet-like wood having flexibility and processability is produced. In addition, since the resin fills the voids in the wood, it is thought that wood damage by insects is also prevented.

### CITATION LIST

### Patent Document

Patent Document 1: JP 3536048 B

### SUMMARY OF INVENTION

### Technical Problem

However, the extent of modification is limited because it is required to impregnate the wood with more than one type of resin, the resin is limited to one having a vapor pressure of 1.3 kPa, and the treatment is substantially limited to treatment of a natural wood sheet having a thickness from 0.15 to 0.17 mm. Therefore, an object of the present invention is to provide a wooden sheet with high flexibility (for example, folding resistance) and processability (for example, degree of processing freedom) even if the wood sheet is considerably thick. Another object is to provide a method by which such a wooden sheet can be produced.

### Solution to Problem

As a result of diligent research to achieve the objects described above, the present inventors discovered that when a natural wood sheet is modified under specific conditions, the wood becomes extremely flexible and processable. The present invention was completed based on these findings.

That is, the present invention provides a modified wooden sheet modified with a modifying agent including a combination of an acid or alkali and a compound having a hydroxyl group.

Preferably, the compound having a hydroxyl group is at least one selected from the group consisting of glycerin, alkylene glycols, polysaccharides, and derivatives thereof.

The thickness of the wooden sheet according to an embodiment of the present invention is preferably from 0.05 to 4 mm.

The specific gravity of the wooden sheet according to an embodiment of the present invention is preferably from 0.2 to 1.5 g/cm³.

The wooden sheet according to an embodiment of the present invention is preferably such that the diameter of a mandrel in a folding resistance test is not greater than 20 mm.

### [Folding Resistance Test]

A plurality of mandrels with different diameters are prepared, and under conditions including a temperature of 25° C., a duration of folding of 1 second, and a folding angle of 180°, a folding is performed by winding a test piece around a mandrel with the largest diameter among the plurality of the mandrels, and visually observing the test piece to determine whether a crease occurs in the wound portion.

Next, another folding is conducted with a mandrel having a smaller diameter than the mandrel of the previous folding, and this process is repeated until folding causes a crease in the test piece. The maximum diameter of the mandrel, at which the folding does not cause a crease in the test piece through the process, is determined.

Note that the present invention also describes a method for producing a wooden sheet, the method including immersing a natural wood sheet in a modifying agent including a combination of an acid or alkali and a compound having a hydroxyl group to modify the natural wood sheet.

The present invention also describes a modifying agent for a natural wood sheet, the modifying agent containing an acid or an alkali and a compound having a hydroxyl group.

### Advantageous Effects of Invention

The wooden sheet according to an embodiment of the present invention overcomes the drawbacks of low flexibility and a tendency to fracture of the natural wood sheets, and also is highly flexible (highly resistant against folding) even if the wooden sheet is considerably thick. Furthermore, the wooden sheet according to an embodiment of the present invention has high processability (degree of processing freedom), and thus can be applied to a wide range of fields and is not limited to the decoration of buildings, vehicles, furniture, electrical products, and the like. In addition, the wooden sheet according to an embodiment of the present invention exhibits high folding resistance even if the wooden sheet is not provided with a backing of reinforcing fibers, resin, or the like. In addition, in a case where the wooden sheet according to an embodiment of the present invention has no layer such as a printed layer or a surface protecting layer on the surface, the wooden sheet is provided with the texture or feel of a natural wood sheet, and thus provides a healing effect or the like. Also, the modifying agent according to an embodiment of the present invention modifies a natural wood sheet, and provides a wooden sheet having high flexibility (folding resistance) and processability (degree of processing freedom).

### BRIEF DESCRIPTION OF DRAWINGS

FIG. 1 illustrates a wooden sheet of an Example 1.

FIG. 2 illustrates a folded state (side view) of the wooden sheet of Example 1.

FIG. 3 illustrates a folded state (top view) of the wooden sheet of Example 1.

FIG. 4 illustrates a state in which one end of the wooden sheet of Example 1 is released after being folded.

FIG. 5 illustrates a wooden sheet of an Example 2.

FIG. 6 illustrates a folded state of the wooden sheet of Example 2 (immediately before “creasing” is observed).

FIG. 7 illustrates a state immediately after “creasing” of the wooden sheet of Example 2 has been observed.

FIG. 8 illustrates a state in which one end of the wooden sheet of Example 2 in which “creasing” was observed is released.

FIG. 9 illustrates a wooden sheet of a Comparative Example 1.

FIG. 10 illustrates a folded state of the wooden sheet of Comparative Example 1 (immediately before “cracking” is observed).

FIG. 11 illustrates a state immediately after “cracking” of the wooden sheet of Comparative Example 1 has been observed.

FIG. 12 illustrates a state in which one end of the wooden sheet of Comparative Example 1 in which “cracking” was observed is released.

FIG. 13 illustrates a wooden sheet of a Comparative Example 2.

FIG. 14 illustrates a folded state of the wooden sheet of Comparative Example 2 (immediately before “cracking” is observed).

FIG. 15 illustrates a state in which one end of the wooden sheet of Comparative Example 2 in which “cracking” was observed is released.

FIG. 16 illustrates an untreated Hinoki cypress sheet (associated with Comparative Example 3).

FIG. 17 illustrates a folded state of the untreated Hinoki cypress sheet (immediately before “cracking” is observed).

FIG. 18 illustrates a state immediately after “cracking” is observed in the untreated Hinoki cypress sheet.

FIG. 19 illustrates a state in which one end of the untreated Hinoki cypress sheet in which “cracking” was observed is released.

### DESCRIPTION OF EMBODIMENTS

A wooden sheet according to an embodiment of the present invention is characterized by being modified by a modifying agent including a combination of an acid or alkali and a compound having a hydroxyl group. Specifically, the wooden sheet according to an embodiment of the present invention is made by modifying a natural wood sheet, which serves as a raw material, using a modifying agent including a combination of an acid or an alkali and a compound having a hydroxyl group. Furthermore, the wooden sheet according to an embodiment of the present invention may be made by immersing a natural wood sheet in a modifying agent including a combination of an acid or an alkali and a compound having a hydroxyl group to thereby modify the natural wood sheet. Note that the wooden sheet according to an embodiment of the present invention is preferably made by immersing and heating a natural wood sheet in a modifying agent including a combination of an acid or an alkali and a compound having a hydroxyl group.

The natural wood sheet that serves as a raw material may be a veneer or a plywood, and may be a complex combination of veneers such as a parquet. Also, examples of natural woods include Japanese Ash, White Sycamore, Mahogany, Zebrano, Makore, Rosewood, Teak, Padauk, Ebony, Birdseye Maple, Anigre, Silky Oak, White Oak, Walnut, American Cherry, Birch, White Ash, Curly Maple, Hard Maple, Hinoki, Zelkowa, Japanese Oak, White Beech, Kiri, Oregon Pine, Bubinga, Japanese nut, Bamboo, Cherry, Japanese Cherry, Cedar, Shina, Wenge, Sapele, Ovangkol, Paldao, Afromosia, Yaku Cedar, Mubingi, Agathis, Yellow Pine, Red Oak, Andes Teak, Kembangs, Fagus, and Balsa.

The thickness of the natural wood sheet is not particularly limited, but, for example, is preferably from 0.05 to 10 mm, more preferably from 0.1 to 4 mm, and even more preferably from 0.2 to 1 mm. When the thickness is set to within the abovementioned range, the produced wooden sheet tends to have flexibility. The embodiment of the present invention is effective in that even when the thickness of the natural wood sheet exceeds 0.2 mm, the produced wooden sheet is highly flexible, and is effective in that even when the thickness of the natural wood sheet exceeds 0.6 mm, the produced wooden sheet exhibits flexibility, and has high strength.

The specific gravity of the natural wood sheet is not particularly limited, but, for example, is preferably from 0.2 to 1.0 g/cm³, more preferably from 0.3 to 0.8 g/cm³, even more preferably from 0.35 to 0.7 g/cm³, and particularly preferably from 0.4 to 0.5 g/cm³. The small specific gravity of the natural wood sheet indicates that the voids in the wood is large. Therefore, it is generally thought that such a natural wood sheet is easily impregnated with the compound having a hydroxyl group, and the produced wooden sheet is flexible. However, an embodiment of the present invention is effective in that the produced wooden sheet exhibits flexibility even if the specific gravity of the natural wood sheet exceeds 0.4 g/cm³.

The modifying agent is characterized in that it includes a combination of an acid or alkali and a compound having a hydroxyl group. In other words, a modifying agent containing a compound having a hydroxyl group and a modifying agent containing an acid or an alkali may be used in combination, or a modifying agent containing an acid or an alkali and a compound having a hydroxyl group may be used, but from the perspectives of convenience of operations and ease of handling, use of a modifying agent containing an acid or alkali and a compound having a hydroxyl group is preferable. That is, the modifying agent may be a natural wood sheet modifying agent containing a compound having a hydroxyl group, and an acid or alkali. Note that cases in which a modifying agent containing a compound having a hydroxyl group is used in combination with a modifying agent containing an acid or an alkali include (1) a case in which a modifying agent containing a compound having a hydroxyl group is used, after which a modifying agent containing an acid or alkali is used, and (2) a case in which a modifying agent containing an acid or alkali is used, after which a modifying agent containing a compound having a hydroxyl group is used. In the case of (1) and (2) above, washing and drying may be included between the steps of using the modifying agents. When a modifying agent containing a compound having a hydroxyl group is used in combination with a modifying agent containing an acid or alkali, the case (2) is preferable, and more preferably, in the case of (2), washing is preferably not included between the steps of using the modifying agents.

The modifying agent may further contain a solvent or an additive besides the compound having a hydroxyl group and the acid or alkali. The compound having a hydroxyl group is not particularly limited, and examples thereof include glycerin, alkylene glycols, polysaccharides, and derivatives thereof. One of these compounds can be used alone, or two or more types can be used in combination.

The derivative of glycerin is not particularly limited as long as it is a compound that contains a glycerin unit in the molecule and has a hydroxyl group. Examples include polyglycerin; glycerin fatty acid esters such as monoglycerin fatty acid esters, polyglycerin fatty acid esters (limited to those having one or more hydroxyl groups); and glycerin alkyl ethers such as monoglycerin alkyl ethers and polyglycerin alkyl ethers (limited to those having one or more hydroxyl groups). Among these, glycerin and polyglycerin are preferable from the perspective of imparting flexibility and processability to the wooden sheet.

Examples of the alkylene glycol include ethylene glycol, propylene glycol, and butylene glycol. Among these, ethylene glycol is preferable from the perspective of imparting flexibility and processability to the wooden sheet.

The derivative of alkylene glycol is not particularly limited as long as the derivative is a compound containing an alkylene glycol unit in the molecule and having a hydroxyl group. Examples thereof include polyalkylene glycol; alkylene glycol fatty acid esters such as monoalkylene glycol fatty acid esters and polyalkylene glycol fatty acid esters (limited to those having one or more hydroxyl groups); and alkylene glycol alkyl ethers such as monoalkylene glycol alkyl ethers and polyalkylene glycol alkyl ethers (limited to those having one or more hydroxyl groups). Among these, alkylene glycol and polyalkylene glycol are preferable from the perspective of imparting flexibility and processability to the wooden sheet.

Examples of polysaccharides and derivatives thereof include starch (amylose, amylopectin), glycogen, cellulose, chitin, chitosan, agarose, carrageenan, heparin, hyaluronic acid, pectin, xyloglucan, alginic acid, and esterified or etherified forms thereof (limited to those having one or more hydroxyl groups). Among these, cellulose and amylose are preferable from the perspective of imparting flexibility to the wooden sheet.

The content of the compound having a hydroxyl group is not particularly limited, and for example, is preferably from 10 to 98 wt. %, more preferably from 30 to 90 wt. %, even more preferably from 40 to 80 wt. %, and particularly preferably from 50 to 75 wt. % with respect to the total amount (100 wt. %) of the modifying agent.

Examples of the acid or alkali include strong acids such as sulfuric acid, hydrochloric acid, nitric acid, and sulfonic acid; carboxylic acids such as acetic acid and oxalic acid; weak acids such as carbonic acid and hydrofluoric acid; strong alkalis such as sodium hydroxide, potassium hydroxide, and calcium hydroxide; salts between acetic acid and an alkali metal or alkaline earth metal, such as sodium acetate, potassium acetate and calcium acetate; salts between carbonic acid and an alkali metal or alkaline earth metal, such as sodium carbonate, potassium carbonate, and calcium carbonate; and ammonia. Among these, from the perspective of the produced wooden sheet or safety of operations in the production stage (for example, safety compared to a strong alkali such as sodium hydroxide), salts between acetic acid or carbonic acid and an alkali metal or alkaline earth metal are more preferable, and salts between carbonic acid and an alkali metal (alkali metal carbonate salts) are particularly preferable. Note that the acid or alkali may be used in the form of an aqueous solution. These can be used alone or as a combination of two or more types.

The content of the acid or alkali is not particularly limited, but is preferably from 0.1 to 50 wt. %, more preferably from 0.5 to 40 wt. %, still more preferably from 1 to 30 wt. %, and particularly preferably from 3 to 20 wt. %, with respect to the modifying agent (100 wt. %).

The solvent that may be included in the modifying agent is not particularly limited as long as the solvent does not adversely affect the modification, and examples include: water; fluorine-based solvents such as trifluorotoluene, fluorobenzene, and fluorohexane; hydrocarbon-based solvents such as aromatic hydrocarbons (for example, benzene, toluene, xylene, chlorobenzene, nitrobenzene, and the like), and aliphatic hydrocarbons (for example, pentane, hexane, heptane, octane, cyclohexane, methylcyclohexane, and the like); ether-based solvents such as 1,2-dioxane, 1,3-dioxane, 1,4-dioxane, tetrahydrofuran, tetrahydropyran, dimethyl ether, diethyl ether, ethylene glycol dimethyl ether, and diethylene glycol dimethyl ether; amide-based solvents such as acetamide, dimethylacetamide, dimethylformamide, diethylformamide, and N-methylpyrrolidone; ester-based solvents such as ethyl acetate, propyl acetate, and butyl acetate; nitrile-based solvents such as acetonitrile and benzonitrile; and halogenated hydrocarbons such as methyl chloride, dichloromethane, trichloromethane (chloroform), 1,2-dichloroethane, 1,1,1-trichloroethane, 1,1,2-trichloroethane, 1,1,2-trichloroethylene, and 1-chlorobutane. Note that when an acid or alkali described below is included in the modifying agent, water is preferably included. One of these solvents can be used alone, or two or more can be used in combination.

The amount of solvent is not particularly limited, but is preferably 95 wt. % or less (for example from 1 to 95 wt. %), more preferably 80 wt. % or less (for example, from 3 to 80 wt. %), even more preferably 50 wt. % or less (for example, from 5 to 50 wt. %), and particularly preferably 30 wt. % (for example, from 10 to 30 wt. %), with respect to the modifying agent (100 wt. %).

Additives that may be included in the modifying agent are not particularly limited as long as they do not adversely affect modification, and examples include perfumes, colorants, preservatives, antioxidants, antioxidant aids, ultraviolet absorbers, moisturizer, and pH adjusting agents. One of these additives can be used alone or two or more can be used in combination.

When the wooden sheet according to an embodiment of the present invention is produced by immersing and heating a natural wood sheet in a modifying agent including a combination of an acid or alkali and a compound having a hydroxyl group to thereby modify the natural wood sheet, the heating temperature thereof is not particularly limited as long as the temperature is room temperature (for example, 25° C.) or higher, but for example, the heating temperature is preferably from 30 to 250° C., more preferably from 50 to 200° C., even more preferably from 80 to 150° C., and particularly preferably from 90 to 120° C. Furthermore, the heating time can be adjusted as appropriate in accordance with the heating temperature and pressure, and for example, the heating time is preferably from 0.1 to 20 hours, more preferably from 0.2 to 10 hours, and even more preferably from 0.3 to 5 hours. Note that the heating treatment can be performed under normal pressure or under pressurization, and when heated under pressurization, the pressure is normally approximately from 0.1 to 10 MPa (preferably from 0.15 to 8 MPa, and particularly preferably from 0.5 to 8 MPa).

As necessary, after the wooden sheet has been modified, the modified wooden sheet can be washed with water and dried to thereby obtain a final targeted product. The temperature when drying is not particularly limited, but is, for example, from 20 to 100° C. The drying time is not particularly limited, but for example, a drying time from 0.1 to 100 hours is preferable.

The wooden sheet excels in folding resistance, and the diameter of the mandrel in the folding resistance test is preferably 20 mm or less, more preferably 10 mm or less, and even more preferably 5 mm or less. Note that measurements can be performed in the folding resistance test using the method described in the Examples. In addition, the “diameter of the mandrel” refers to the maximum diameter of the mandrel at which a crease is not produced when the mandrel is changed to one with a smaller diameter until a crease is produced in the wooden sheet. In other words, the expression “the diameter of the mandrel is 16 mm” means that a crease was not produced in the wooden sheet when the diameter of the mandrel was 16 mm, but a crease was produced in the wooden sheet when the diameter of the mandrel was 12 mm.

The thickness of the wooden sheet is not particularly limited, but, for example, is preferably from 0.05 to 10 mm, more preferably from 0.1 to 4 mm, and even more preferably from 0.2 to 1 mm. When the thickness is within the range described above, the wooden sheet tends to have high flexibility and processability. The wooden sheet also has a high strength when the wooden sheet is relatively thick (for example, a thickness of greater than 0.2 mm, and preferably greater than 0.6 mm). Therefore, a wooden sheet having such a thickness is particularly useful in applications that require not only flexibility but also a certain degree of strength required for a structural member, such as applications in wall surfaces of a building having curved surfaces, and in vehicle members such as door trims, instrument panels, and pillar covers.

The specific gravity of the wooden sheet is not particularly limited, but is preferably from 0.2 to 1.5 g/cm³, more preferably from 0.3 to 1.3 g/cm³, even more preferably from 0.5 to 1.2 g/cm³, and particularly preferably from 0.8 to 1.1 g/cm³. When the specific gravity is within the range described above, the flexibility, processability, and strength of the wooden sheet tend to increase.

The wooden sheet according to an embodiment of the present invention may be reinforced using a backing material such as Japanese paper, western paper, synthetic paper, cheesecloth, nonwoven fabric, canvas, pigskin, and synthetic resin sheets. Note that these backing materials may be affixed using an ordinary method. The use of the backing material may improve dimensional stability, folding resistance, and the like. However, the wooden sheet according to an embodiment of the present invention exhibits high folding resistance even when the wooden sheet is not reinforced with a backing using a backing material.

The wooden sheet according to an embodiment of the present invention may have a layer such as a printed layer or a surface protective layer on a surface (surface opposite the backing material), so long as the flexibility or the like is not impaired. The layers are formed by applying a heat or photocurable resin composition containing a printing ink or the like as necessary, and then drying the composition.

The abovementioned composition is not particularly limited as long as it does not affect the characteristics of the wooden sheet according to an embodiment of the present invention, and examples of the composition include compositions containing polyester-based resins such as polyethylene terephthalate (PET), polyethylene-2,6-naphthalate, polypropylene terephthalate, polybutylene terephthalate, cyclohexane dimethanol copolymer polyester resin, isophthalic acid copolymerized polyester resin, sporoglycol copolymer polyester resin, and fluorene copolymer polyester resin; polyolefin-based resins such as polyethylene, polypropylene (homopolymer, random copolymer, block copolymer), polymethylpentene, and alicyclic olefin copolymer resins; acrylic resins such as polymethyl methacrylate; and polycarbonates, polystyrenes, polyamides, polyethers, polyester amides, polyether esters, polyvinyl chloride, cycloolefin polymers, polyacrylonitrile copolymers, and acrylonitrile styrene copolymers. Furthermore, a natural resin paint such as a lacquer is also exemplified as the composition.

The composition can be applied by a known method such as gravure coating, bar coating, roll coating, reverse roll coating, and comma coating, with the thickness of the layer after curing being, for example, from 0.01 to 2 mm (preferably from 0.02 to 1 mm, and more preferably from 0.05 to 0.5 mm).

### EXAMPLES

Hereinafter, the present invention will be described in more detail based on examples, but the present invention is not limited by these examples.

### Example 1

A Hinoki cypress sheet (9 cm long, 5 cm wide, and 0.7 mm thick) was heated for 30 minutes at 100° C. in a mixed solution of 100 g of glycerin (available from Kenei Pharmaceutical Co., Ltd.) and 50 g of a saturated aqueous solution of sodium carbonate (available from Kaneyo Soap Co., Ltd.). After the completion of heating, the Hinoki cypress sheet was cooled to room temperature, and washed with water and dried (left at room temperature for 72 hours), and a wooden sheet was produced. The weight was 3.3 g, the specific gravity was 1.0 g/cm³, and the color was brown.

### Example 2

A Hinoki cypress sheet (9 cm long, 5 cm wide, and 0.7 mm thick) was heated for 30 minutes at 100° C. in 100 g of a saturated aqueous solution of sodium carbonate (available from Kaneyo Soap Co., Ltd.). After the completion of heating, the Hinoki cypress sheet was cooled to room temperature, and washed with water and dried (left at room temperature for 72 hours). Next, the Hinoki cypress sheet was heated for 30 minutes at 100° C. in 100 g of glycerin (available from Kenei Pharmaceutical Co., Ltd.), and after heating was completed, the sheet was cooled to room temperature. Then, the sheet was washed with water and dried (left at room temperature for 72 hours). And thus, a wooden sheet was produced. The weight was 4.0 g, the specific gravity was 1.3 g/cm³, and the color was brown.

### Comparative Example 1

A Hinoki cypress sheet (9 cm long, 5 cm wide, and 0.7 mm thick) was heated for 30 minutes at 100° C. in a mixed solution of 100 g of a glycerin (available from Kenei Pharmaceutical Co., Ltd.) and 50 g of water. After the completion of heating, the Hinoki cypress sheet was cooled to room temperature, and washed with water and dried (left at room temperature for 72 hours). And thus, a wooden sheet was produced. The weight was 4.2 g, the specific gravity was 1.3 g/cm³, and the color was deep yellow.

### Comparative Example 2

A Hinoki cypress sheet (9 cm long, 5 cm wide, and 0.7 mm thick) was heated for 30 minutes at 100° C. in 100 g of a saturated aqueous solution of sodium carbonate (available from Kaneyo Soap Co., Ltd.). After the completion of heating, the Hinoki cypress sheet was cooled to room temperature, and washed with water and dried (left at room temperature for 72 hours). And thus, a wooden sheet was produced. The weight was 1.7 g, the specific gravity was 0.54 g/cm³, and the color was light yellow.

### [Folding Resistance Test 1]

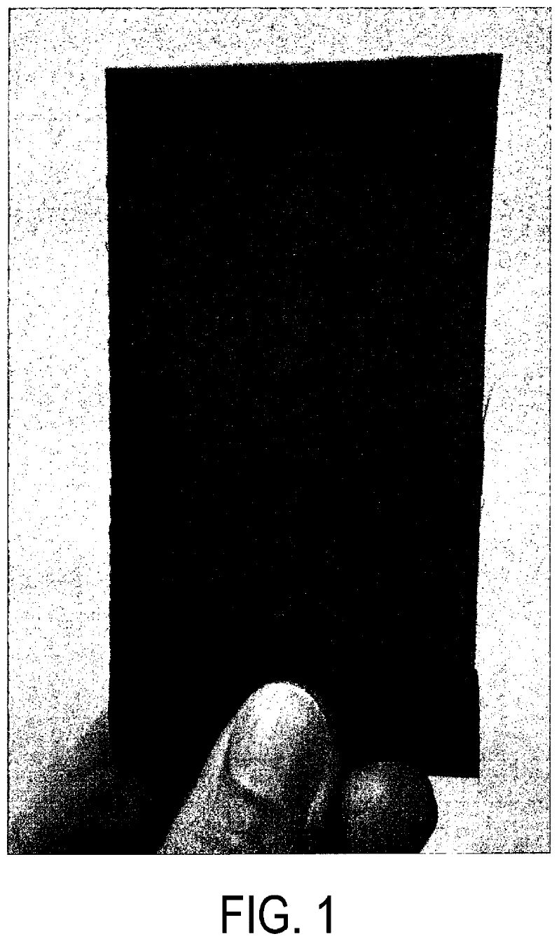

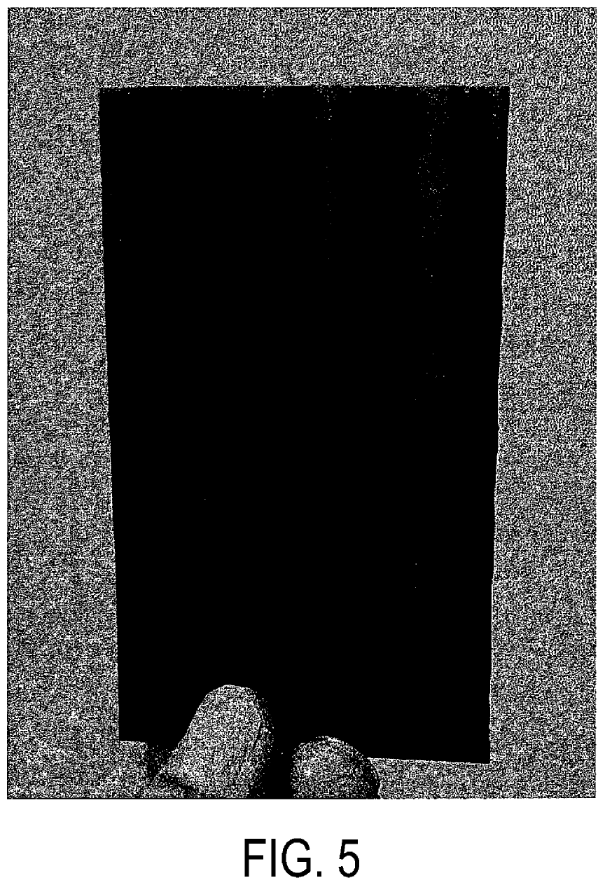

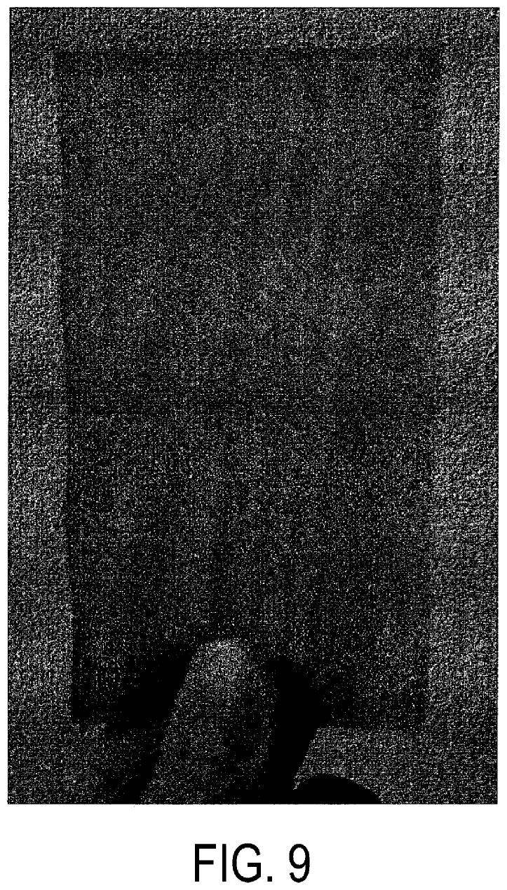

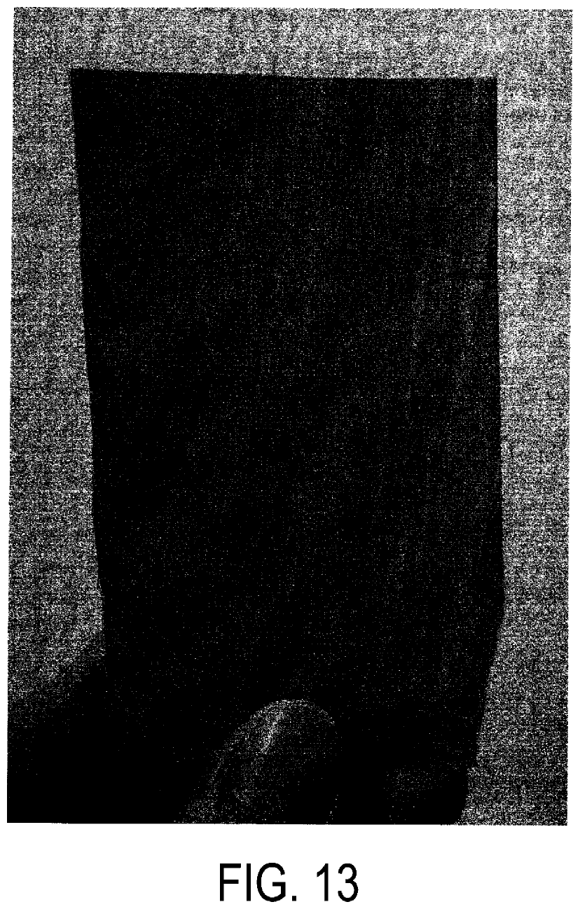

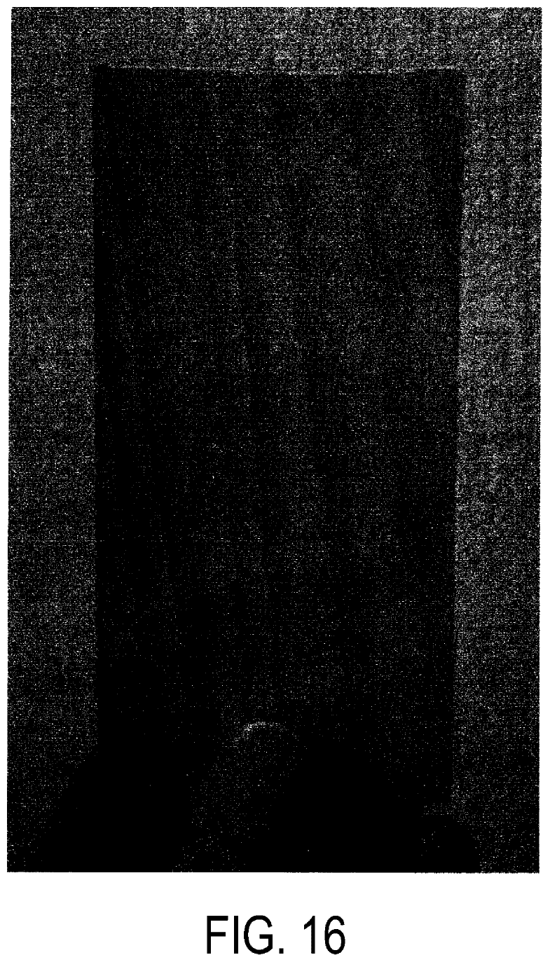

The wooden sheets produced in Examples 1 and 2 and Comparative Examples 1 and 2, and a Hinoki cypress sheet, which had not been treated in any way, serving as Comparative Example 3 (specific gravity of 0.41 g/cm³), were cut into 1×9 cm rectangles to form test pieces (illustrated in FIGS. 1, 5, 9, 13 and 16, respectively), and the folding resistance of each test piece was determined based on the following method. Note that the temperature was 25° C., the duration of folding was 1 second, the folding direction was to make the fold line perpendicular to the grain, and the folding angle was 180° (a state in which the planes of the folded test piece were in parallel).

### (Method for Determining Folding Resistance)

[1] A plurality of mandrels with different diameters were prepared, a folding was performed by winding the test piece around the mandrel with the largest diameter among the plurality of the mandrels, and visually observing the test piece to determine whether a crease occurred in the wound portion.

[2] Another folding was conducted with a mandrel having a smaller diameter than the mandrel of the previous folding, and this process was repeated until folding caused a crease in the test piece.

[3] The maximum diameter of the mandrel, at which the folding did not cause a crease in the test piece through the process, was determined.

Through the method, a crease was not produced in the test piece of Example 1 using a mandrel with a diameter of 4 mm, but a crease was produced using a mandrel with a diameter of 3 mm. That is, the diameter of the mandrel in the folding resistance test was 4 mm. In addition, a crease was not produced in the test piece of Example 2 using a mandrel having a diameter of 20 mm, but a crease was produced when a mandrel with a diameter of 16 mm was used. That is, the diameter of the mandrel in the folding resistance test was 20 mm. On the other hand, the test pieces of Comparative Examples 1 to 3 were creased even with a mandrel having a diameter of 32 mm. Note that in the Examples, mandrels having diameters of 2, 3, 4, 5, 6, 8, 10, 12, 13, 16, 20, 25 and 32 mm were used.

### [Folding Resistance Test 2]

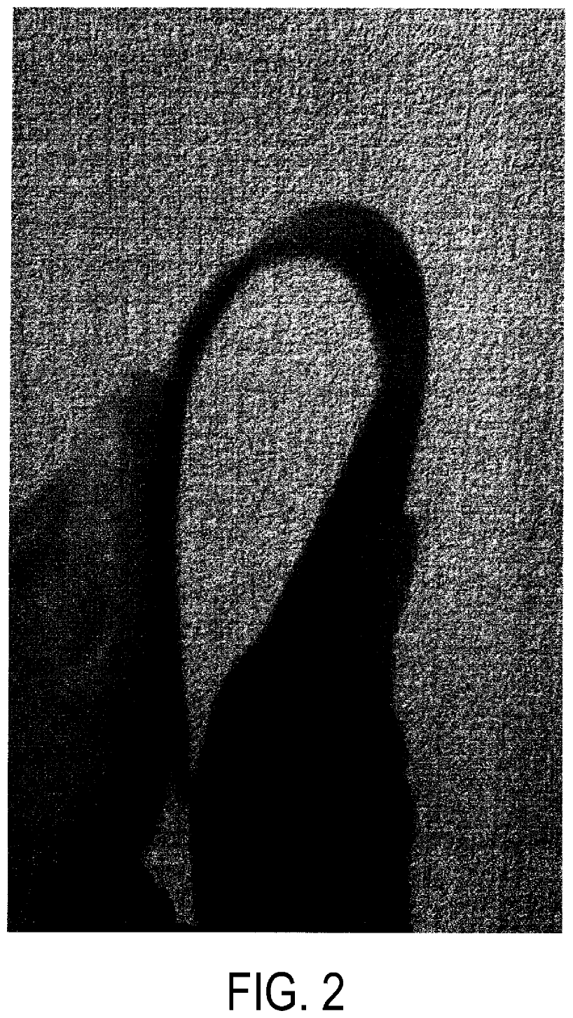

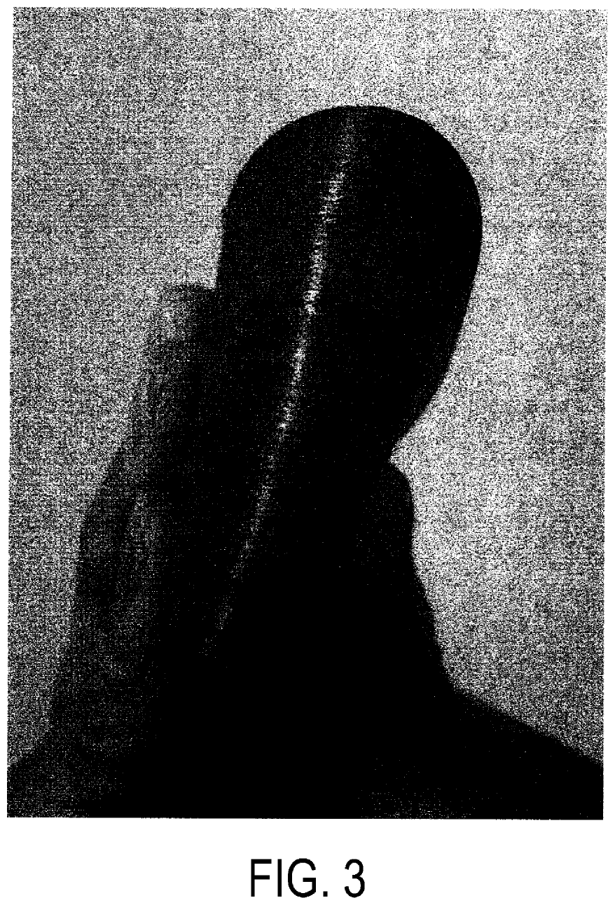

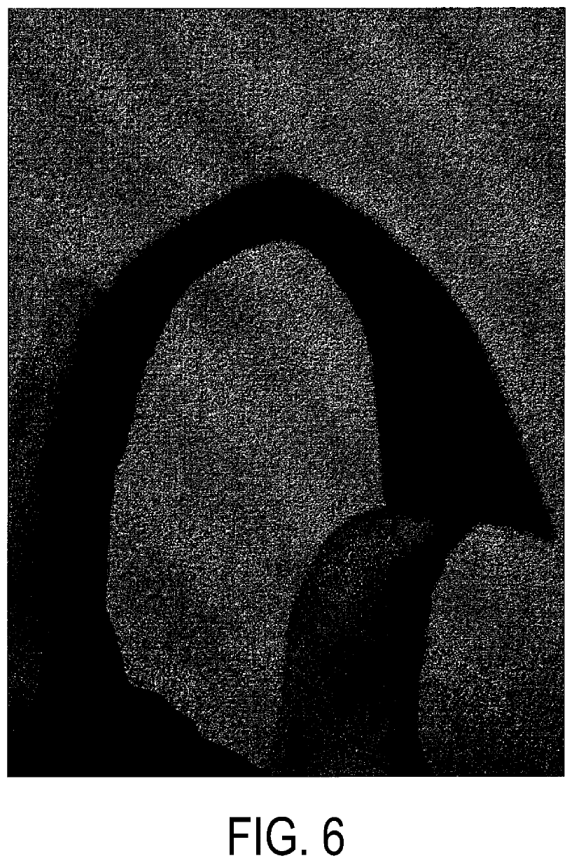

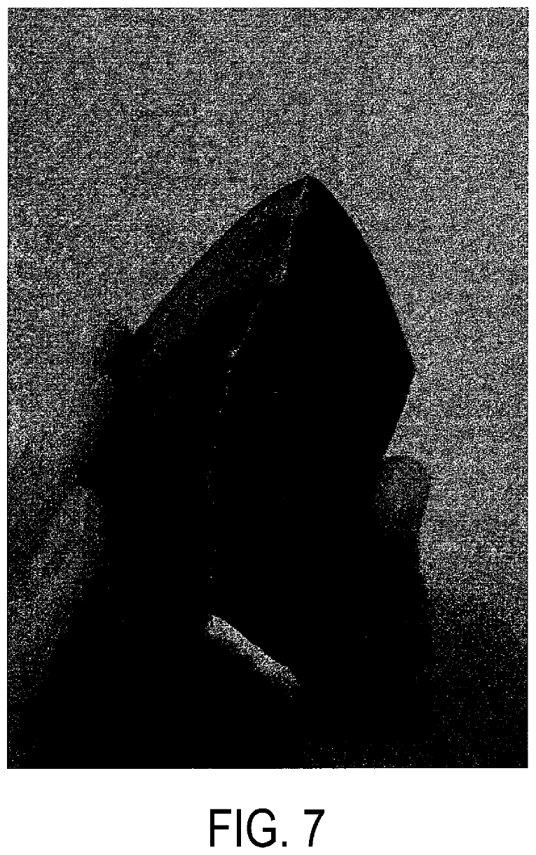

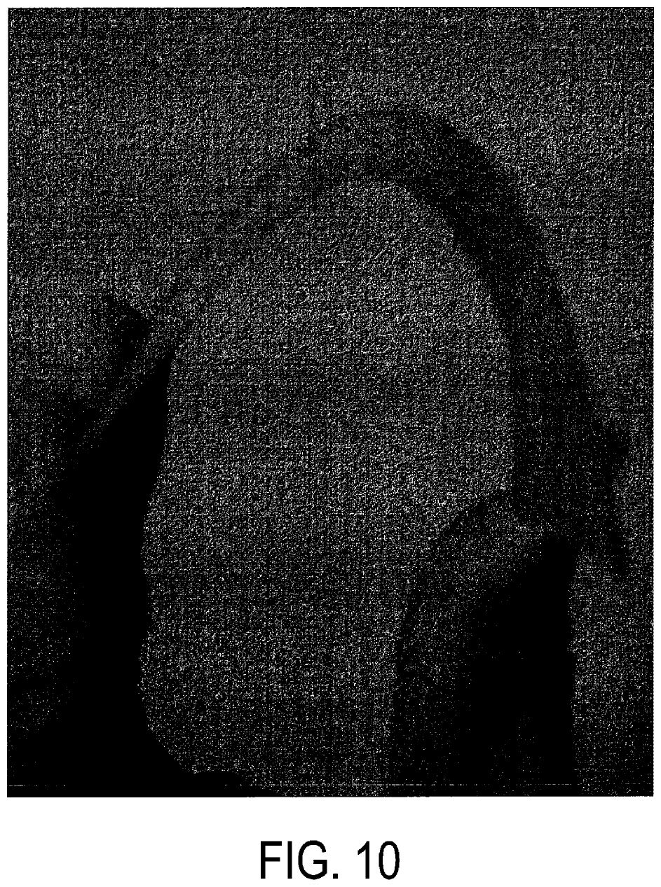

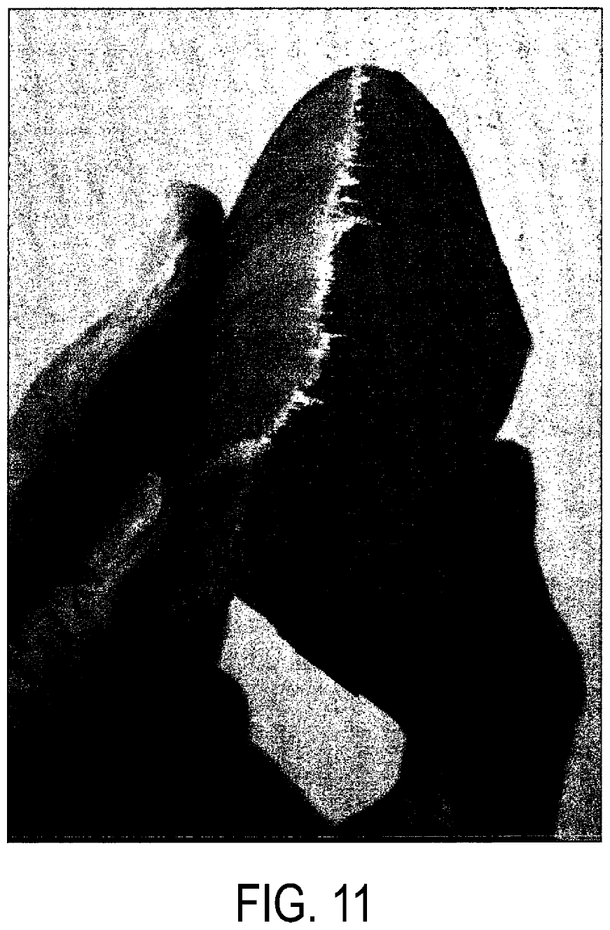

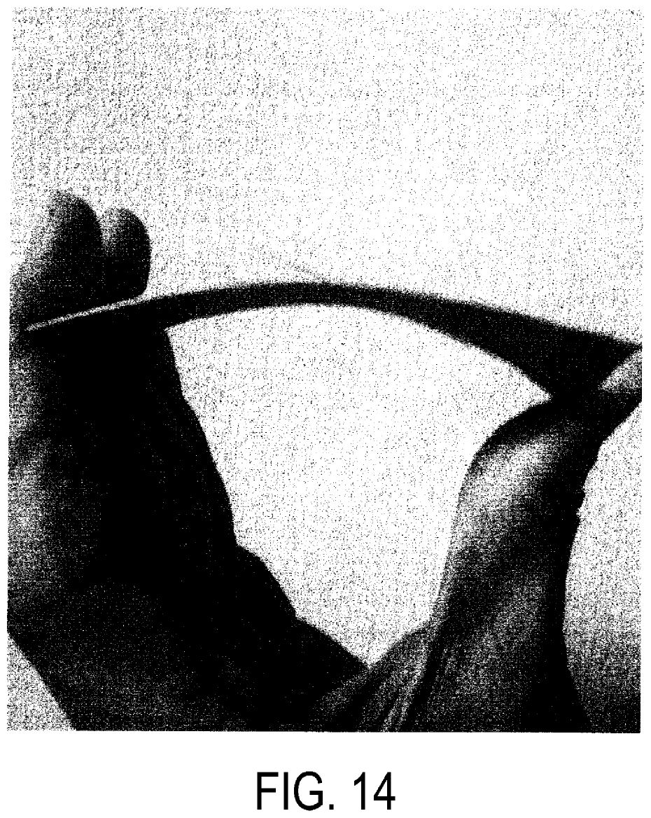

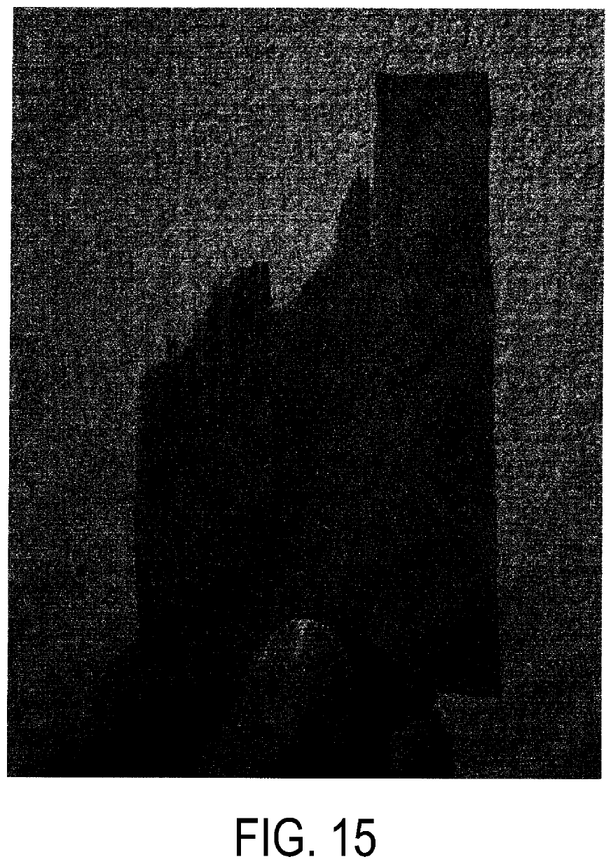

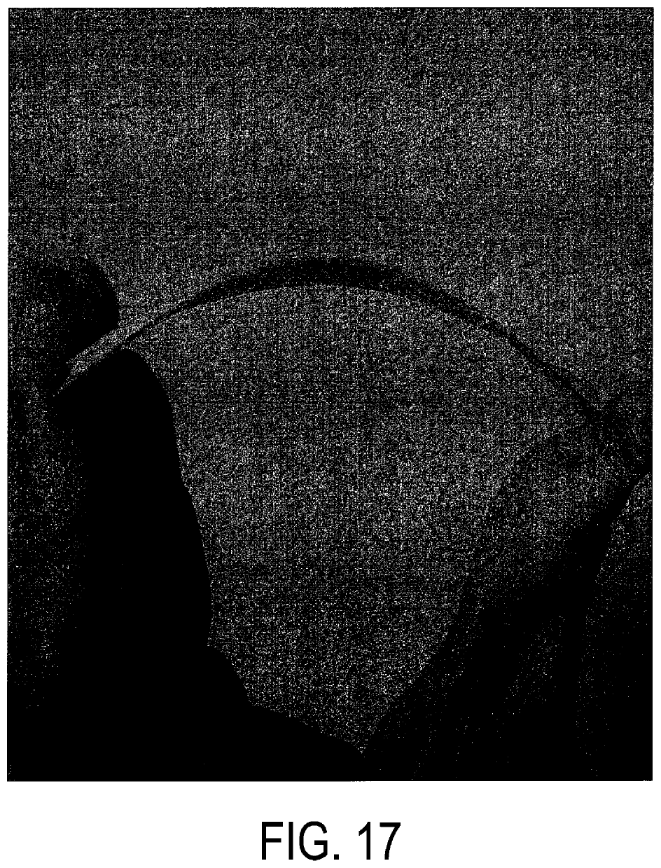

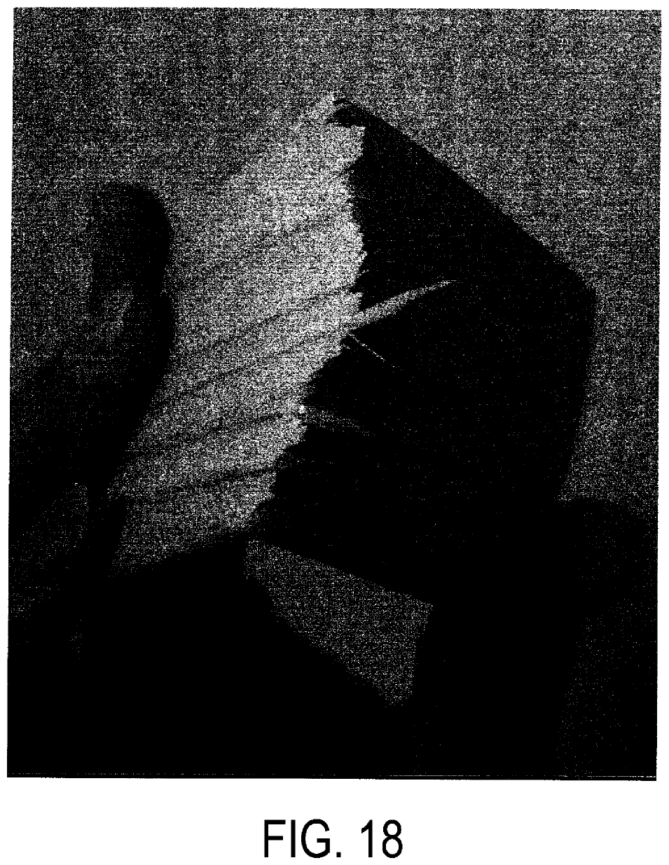

The test pieces of Examples 1 and 2 and Comparative Examples 1 to 3 were folded by hand in a direction in which the fold line was perpendicular to the grain, and it was confirmed whether “creasing” or “cracking” was observed. As a result, the test piece of Example 1 was very flexible, and “creasing” and “cracking” were not observed (FIGS. 2 and 3). The test piece of Example 2 was flexible, but when the folding width was increased, “creasing” was observed (FIGS. 6 and 7). The test piece of Comparative Example 1 exhibited flexibility, but “cracking” was observed when the test piece was folded to some extent (FIGS. 10 and 11). The test piece of Comparative Example 2 became brittle and was inferior in flexibility (became hard), and “cracking” was observed without the test piece being substantially folded (FIGS. 14 and 15). Comparative Example 3 was subjected to the folding resistance test as a control test and exhibited the flexibility of an ordinary natural tree, and “cracking” was observed (FIGS. 17 and 18). Note that “creasing” and “cracking” were determined based on the following criteria.

a) Difference in appearance: Fold lines (not limited to straight lines) were observed with both “cracking” and “creasing”. However, with “cracking”, the “splintering” caused by the breakage of wood fibers could be visually confirmed (see FIGS. 11, 15 and 18), whereas with “creasing”, splintering could not be visually confirmed (see FIG. 7).

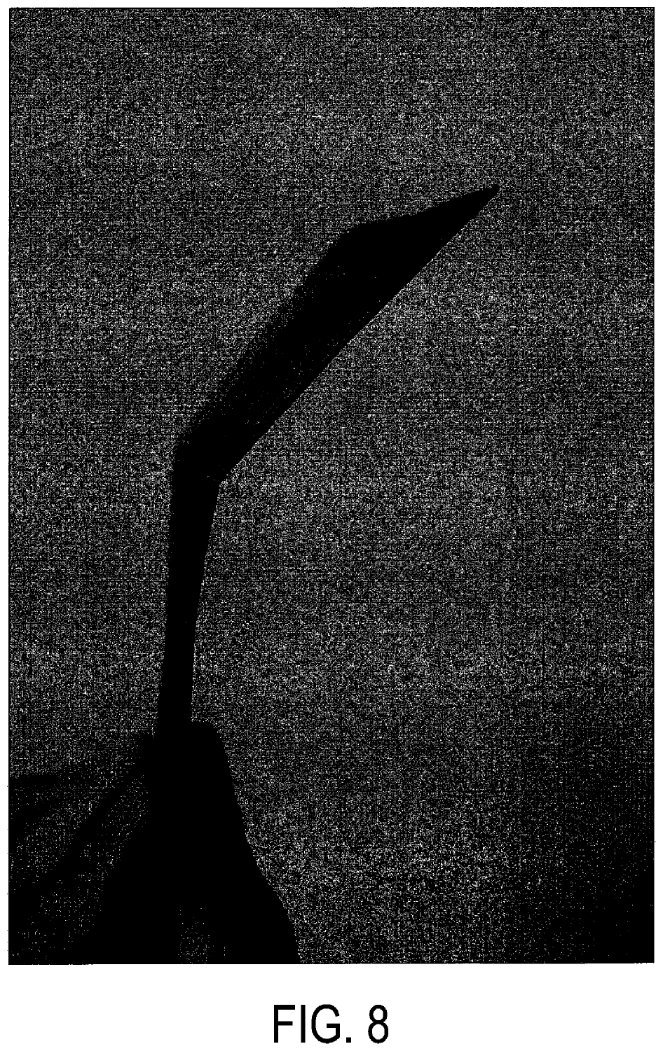

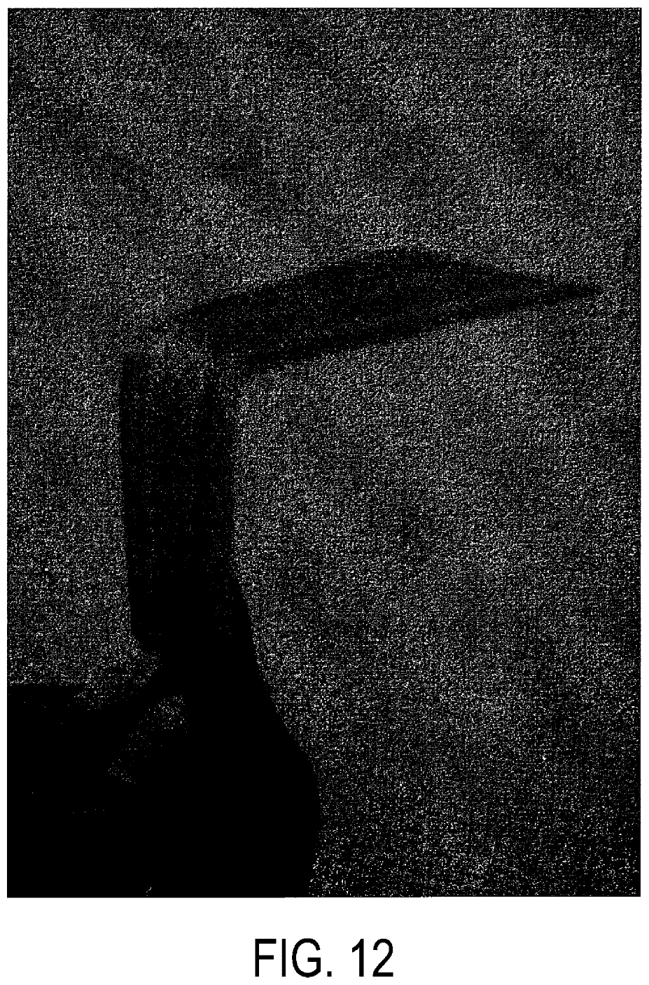

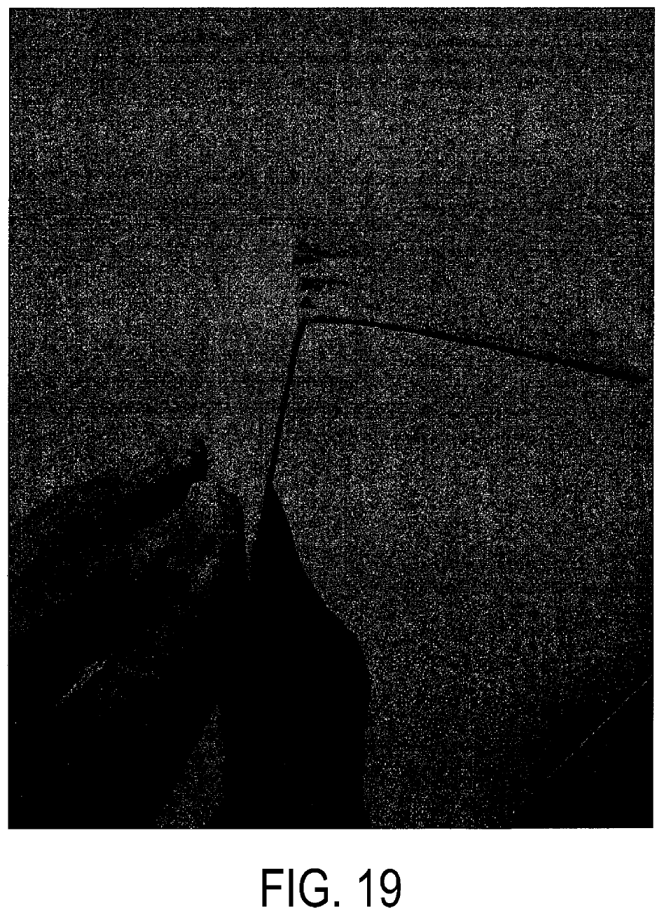

b) Difference in physical properties: After testing, when one end of the test piece was released, the test piece could restore its original shape in the case of “creasing” (see FIG. 8), but the test piece failed to restore the shape in the case of “cracking” (see FIGS. 12, 15 and 19).

The above results are summarized. The wooden sheets that were produced by an alkali treatment and subsequent washing and drying were more brittle than the raw material wood (Hinoki cypress sheet) (see Comparative Examples 2 and 3). It is presumed that woody components such as lignin and cellulose in the wood were decomposed by the alkali treatment and the strength of the wood decreased. In addition, although some flexibility was observed in the wooden sheet that was produced by a glycerin treatment and subsequent washing and drying, the wooden sheet did not have the desired folding characteristics (Comparative Example 1). However, surprisingly, it was clear that the wooden sheets, which had been subjected to a combination of a glycerin treatment and an alkali treatment and then washed and dried, not only exhibited the desired flexibility but also exhibited sufficient strength of wood without becoming brittle (Examples 1 and 2). Note that in a case where the alkali treatment and the glycerin treatment were performed simultaneously (Example 1), the wooden sheet exhibited higher flexibility (folding resistance) and strength than the wooden sheet of the case where the glycerin treatment was performed sequentially after the alkali treatment (Example 2). On the other hand, it was found that when the alkali treatment and glycerin treatment were performed simultaneously (Example 1), the wooden sheet exhibited weaker shape restorability after the folding test (strong plastic deformability), whereas when the treatments were performed sequentially (Example 2), the wooden sheet exhibited stronger shape restorability (elastic deformability) than the wooden sheet of the case where the treatment were performed simultaneously (Example 1).

In Examples 1 and 2, the test pieces did not exhibit weakening of the wood, which was caused by the alkali treatment as indicated in Comparative Example 2. The reason why Examples 1 and 2 exhibited high flexibility and strength is not clear, but the following may be conceivable: [1] a reaction between glycerin and lignin or cellulose occurred through the alkali and resulted in crosslinking, and thereby the flexibility and strength of the wood were improved; [2] conversely to [1], due to the presence of glycerin, specific sites of lignin or cellulose in the wood were hydrolyzed via the alkali, and thereby the flexibility and strength of the wood were improved (in a case where glycerin was not present, the wood was weakened because hydrolysis occurred throughout the entire wood); [3] even with a relatively thick wood piece, the alkali and glycerin were miscible, and could permeate into the wood, and as a result, flexibility was improved, [4] the presence of the alkali widened the void sections in the wood, and thereby facilitated the penetration of glycerin into the wood, and therefore flexibility was improved; and [5] the dry and solidified cellulose, lignin, or decomposition products thereof in the voids of the wood were efficiently eluted by the miscible solution of the alkali and glycerin, and flexibility was improved. In this manner, the wooden sheet of the present application has high flexibility and strength, and thus it is clear that the wooden sheet of the present invention exhibits high processability.

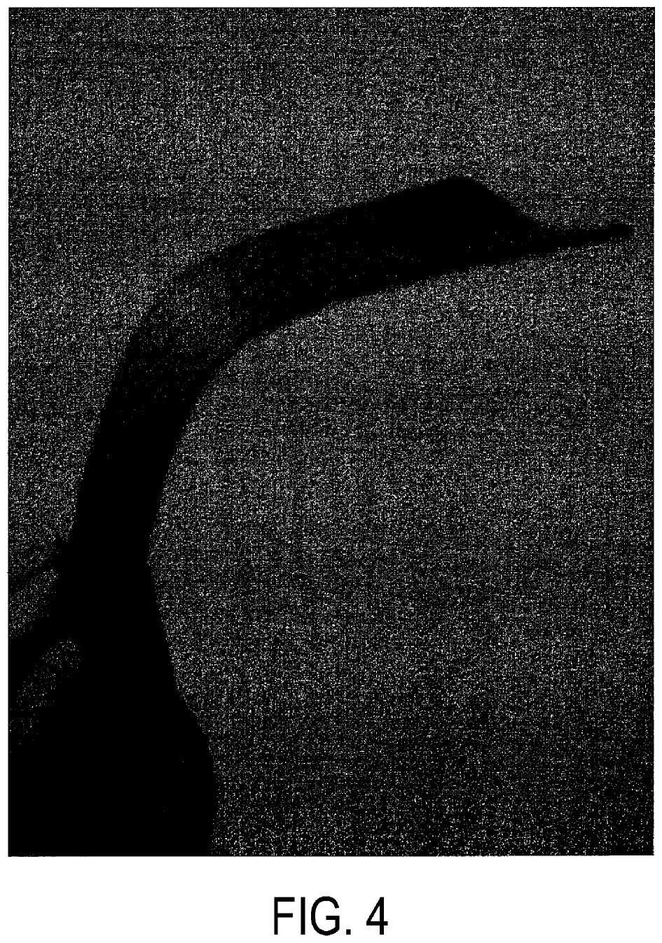

When one end of the test piece of Example 1 was released after the folding resistance test 2, it was found that the test piece returned to the original shape (shape before testing) to some extent, but the restorability was weak when compared to the folded state. In other words, the test piece of Example 1 exhibited weak elastic deformability (a property for which, when an object is subjected to an external force and deformed, and then the external force is removed, the object in a deformed state returns to the original state). Even if the test piece was folded to the point that both ends are in contact, “creasing” and “cracking” were not observed (yield point is not reached), and therefore it is thought that the test piece of Example 1 exhibited strong plastic deformability as a whole (a property for which, when an object is subjected to an external force and deformed, the object does not return to its original state even if the external force is removed) (FIGS. 3 and 4). Furthermore, with the test pieces of Comparative Examples 1 to 3 in which “cracking” was observed, while there was some degree of difference in the elastic deformability and plastic deformability, it was found that these test pieces of Comparative Examples exhibited relatively weak elastic deformability and plastic deformability, and quickly reached their yield points. On the other hand, in Example 2, “creasing” was observed when the test piece was significantly folded, and therefore the test piece appeared to have reached a yield point as in Comparative Examples 1 to 3. However, surprisingly, when one end of the test piece was released, the test piece was unexpectedly restored to a large extent (FIGS. 7 and 8). Therefore, it is thought that the yield of the test piece of Example 2 was only apparent or only partially reached to a very small extent, and thus the test piece of Example 2 exhibited strong elastic deformability, but weak plastic deformability.

It is surmised that the difference between the characteristics of Example 1 and Example 2 is due to whether the alkali treatment and glycerin treatment are performed simultaneously or sequentially. In other words, it is surmised that characteristic of weak elastic deformability and strong plastic deformability of the produced wooden sheet is due to simultaneous alkali treatment and glycerin treatment. Furthermore, it is surmised that the characteristic of strong elastic deformability and weak plastic deformability of the produced wooden sheet is due to the sequential treatments of glycerin treatment after the alkali treatment. While the reasons for this difference are not clear, it is thought that the difference in the characteristics is due to the wooden sheet of Example 2 being heavier than that of Example 1, i.e. in Example 1, there is a possibility that the cellulose, lignin, or decomposition products thereof had been dried and solidified in the voids of the test piece (wood) and then efficiently had eluted out.

Plastic deformability is a characteristic that is not found in ordinary natural wood. Similar to plastics (in particular, thermoplastic resins), a wooden sheet with this characteristic has the potential to be molded and processed into a variety of shapes by applying heat, stress, or the like as necessary. Therefore, use of molded products of such wooden sheets as environmentally-friendly wooden molded products is expected as an alternative to petroleum-based plastic molded products. Furthermore, various applications can be anticipated, such as new wooden molded products having properties (that are unique to wood) that cannot be obtained in petroleum-based plastics molded products, wooden molded products having shapes that are difficult to achieve with processing of ordinary wood, and wooden molded products that are more crack-resistant (less brittle) than conventional wood processed products.

Wooden sheets according embodiments of the present invention feature high flexibility (for example, folding resistance) and high processability (for example, degree of processing freedom). Therefore, the wooden sheets can be used in building materials (construction materials) such as floor materials, interior and exterior wall materials, interior and exterior base materials, ceiling materials, window frames, and baseboards; in vehicles (vehicle components) such as door trims, instrument panels, and pillar covers; and in furniture (surface materials of furniture), consumer electronics (housing or surface layers, etc. of consumer electronics), and the like. In addition, the wooden sheets of the present invention can also be used as a constituent member of tableware such as cups, bottles, lacquerware, and lunch boxes, of containers such as boxes, barrels, and rounded lunch boxes, and of musical instruments such as guitars, and pianos, and the like.

To summarize the above, configurations of the present invention and variations thereof will be described below.

[1] A wooden sheet modified with a modifying agent, the modified agent including a combination of an acid or an alkali and a compound having a hydroxyl group.

[2] The wooden sheet according to [1], wherein the compound having a hydroxyl group is at least one selected from the group consisting of glycerin, alkylene glycols, polysaccharides, and derivatives thereof.

[3] The wooden sheet according to [1] or [2], produced by immersing a natural wood sheet in a modifying agent including a combination of an acid or an alkali and a compound having a hydroxyl group to thereby modify the natural wood sheet. [4] The wooden sheet according to any one of [1] to [3], produced by immersing and heating a natural wood sheet in a modifying agent including a combination of an acid or alkali and a compound having a hydroxyl group, and heating to thereby modify the natural wood sheet.

[5] The wooden sheet according to any one of [1] to [4], modified and produced by (1) using a modifying agent containing a compound having a hydroxyl group, and subsequently using a modifying agent containing an acid or an alkali, or (2) using a modifying agent containing an acid or an alkali, and subsequently using a modifying agent containing a compound having a hydroxyl group.

[6] The wooden sheet according to any one of [2] to [5], wherein the derivative of glycerin is polyglycerin.

[7] The wooden sheet according to any one of [2] to [6], wherein the alkylene glycol is ethylene glycol, propylene glycol, or butylene glycol.

[8] The wooden sheet according to any one of [2] to [7], wherein the derivative of alkylene glycol is an alkylene glycol or a polyalkylene glycol.

[9] The wooden sheet according to any one of [2] to [8], wherein the polysaccharide and derivative thereof is cellulose or amylose.

[10] The wooden sheet according to any one of [1] to [9], wherein the compound having a hydroxyl group is glycerin.

[11] The wooden sheet according to any one of [1] to [10], wherein a content of the compound having a hydroxyl group is from 10 to 98 wt. %, from 30 to 90 wt. %, from 40 to 80 wt. %, or from 50 to 75 wt. % relative to the total amount (100 wt. %) of the modifying agent.

[12] The wooden sheet according to any one of [1] to [11], wherein the acid or alkali is a strong acid such as sulfuric acid, hydrochloric acid, nitric acid, or sulfonic acid; a carboxylic acid such as acetic acid or oxalic acid; a weak acid such as carbonic acid and hydrofluoric acid; a strong alkali such as sodium hydroxide, potassium hydroxide, or calcium hydroxide; a salt between acetic acid and an alkali metal or alkaline earth metal, such as sodium acetate, potassium acetate or calcium acetate; a salt between carbonic acid and an alkali metal or alkaline earth metal, such as sodium carbonate, potassium carbonate, or calcium carbonate; or ammonia; and is preferably a salt between acetic acid or carbonic acid and an alkali metal or alkaline earth metal, and is more preferably a salt between carbonic acid and an alkali metal (alkali metal carbonate salt).

[13] The wooden sheet according to any one of [1] to [12], wherein the acid or alkali is sodium carbonate.

[14] The wooden sheet according to any one of [1] to [13], wherein the content of the acid or alkali is from 0.1 to 50 wt. %, from 0.5 to 40 wt. %, from 1 to 30 wt. % or from 3 to 20 wt. % with respect to the modifying agent (100 wt. %).

[15] The wooden sheet according to any one of [1] to [14], wherein the wooden sheet is produced by immersing and heating a natural wood sheet in a modifying agent including a combination of an acid or alkali and a compound having a hydroxyl group to thereby modify the natural wood sheet; wherein the heating temperature is room temperature (for example, 25° C.) or higher, from 30 to 250° C., from 50 to 200° C., from 80 to 150° C., or from 90 to 120° C.; and the heating time is from 0.1 to 20 hours, from 0.2 to 10 hours, or from 0.3 to 5 hours.

[16] The wooden sheet according to any one of [1] to [15], wherein the thickness is from 0.05 to 10 mm, from 0.1 to 4 mm, or from 0.2 to 1 mm.

[17] The wooden sheet according to any one of [1] to [16], wherein the specific gravity is from 0.2 to 1.5 g/cm³, from 0.3 to 1.3 g/cm³, from 0.5 to 1.2 g/cm³, or from 0.8 to 1.1 g/cm³.

[18] The wooden sheet according to any one of [1] to [17], wherein a diameter of a mandrel in a folding resistance test described below is not greater than 20 mm, not greater than 10 mm, or not greater than 5 mm.

### [Folding Resistance Test]

A plurality of mandrels with different diameters are prepared, and under conditions including a temperature of 25° C., a duration of folding of 1 second, and a folding angle of 180°, a folding is performed by winding a test piece around a mandrel with the largest diameter among the plurality of the mandrels, and observing the test piece visually to determine whether a crease occurred in the wound portion. Next, another folding is conducted with a mandrel having a smaller diameter than the mandrel of the previous folding, and this process is repeated until the folding causes a crease in the test piece. The maximum diameter of the mandrel, at which the folding did not cause a crease in the test piece through the process, is determined.

[19] A method for producing a modified wooden sheet, the method including immersing a natural wood sheet in a modifying agent including a combination of an acid or an alkali and a compound having a hydroxyl group to modify the natural wood sheet.

[20] A modifying agent for a natural wood sheet, the modifying agent including an acid or an alkali and a compound having a hydroxyl group.

### INDUSTRIAL APPLICABILITY

The wooden sheet according to an embodiment of the present invention overcomes the drawbacks of low flexibility and a tendency to fracture of the natural wood sheets, and also is highly flexible (highly resistant against folding) even if the wooden sheet is considerably thick. Furthermore, the wooden sheet according to an embodiment of the present invention has high processability (degree of processing freedom), and thus can be applied to a wide range of fields and is not limited to the decoration of buildings, vehicles, furniture, electrical products, and the like. In addition, the wooden sheet according to an embodiment of the present invention exhibits high folding resistance even if the wooden sheet is not provided with a backing of reinforcing fibers, resin, or the like. In addition, in a case where the wooden sheet according to an embodiment of the present invention has no layer such as a printed layer or a surface protecting layer on the surface, the wooden sheet is provided with the texture or feel of a natural wood sheet, and thus provides a healing effect or the like. Also, the modifying agent according to an embodiment of the present invention modifies a natural wood sheet, and provides a wooden sheet having high flexibility (folding resistance) and processability (degree of processing freedom).

1. A wooden sheet modified with a modifying agent, the modified agent including a combination of an acid or an alkali and a compound having a hydroxyl group,
wherein the wooden sheet has a thickness from 0.05 to 4 mm,
wherein a diameter of a mandrel in a folding resistance test is not greater than 20 mm, and
wherein, in the folding resistance test,
a plurality of mandrels with different diameters are prepared, and under conditions including a temperature of 25° C., a duration of folding of 1 second, and a folding angle of 180°, a folding is conducted by winding a test piece around a mandrel with the largest diameter among the plurality of the mandrels, and observing the test piece visually to determine whether a crease has occurred in the wound portion; then, another folding is conducted with a mandrel having a smaller diameter than the mandrel of the previous folding, and this process is repeated until the folding causes a crease in the test piece; and the maximum diameter of the mandrel at which the folding does not cause a crease in the test piece through the process is determined.

2. The wooden sheet according to claim 1, wherein the compound having a hydroxyl group is at least one selected from the group consisting of glycerin, alkylene glycols, polysaccharides, and derivatives thereof.

3. (canceled)

4. The wooden sheet according to claim 1, wherein the wooden sheet has a specific gravity from 0.2 to 1.5 g/cm³.

5. (canceled)

6. A method for producing a wooden sheet, the method comprising immersing a natural wood sheet in a modifying agent including a combination of an acid or an alkali and a compound having a hydroxyl group to modify the natural wood sheet,
wherein the wooden sheet has a thickness from 0.05 to 4 mm,
wherein a diameter of a mandrel in a folding resistance test is not greater than 20 mm, and
wherein, in the folding resistance test,
a plurality of mandrels with different diameters are prepared, and under conditions including a temperature of 25° C., a duration of folding of 1 second, and a folding angle of 180°, a folding is conducted by winding a test piece around a mandrel with the largest diameter among the plurality of the mandrels, and observing the test piece visually to determine whether a crease has occurred in the wound portion; then, another folding is conducted with a mandrel having a smaller diameter than the mandrel of the previous folding, and this process is repeated until the folding causes a crease in the test piece; and the maximum diameter of the mandrel at which the folding does not cause a crease in the test piece through the process is determined.

7. A modifying agent for a natural wood sheet, the modifying agent comprising an acid or an alkali and a compound having a hydroxyl group.
